(19) United States
(12) Patent Application Publication
(10) Pub. No.: US 2012/0185146 A1
(43) Pub. Date: Jul. 19, 2012

(54) METHOD AND DEVICE FOR AUTOMATICALLY PRODUCING MAP CHARACTERISTIC CURVE STRUCTURES FOR REGULATING AND/OR CONTROLLING A SYSTEM, IN PARTICULAR AN INTERNAL COMBUSTION ENGINE

(76) Inventors: Martin JOHANNABER, Schwieberdingen (DE); Marcus BOUMANS, Ludwigsburg (DE)

(21) Appl. No.: 13/343,380

(22) Filed: Jan. 4, 2012

(30) Foreign Application Priority Data
Jan. 14, 2011 (DE) 102011002678.9

(51) Int. Cl. F02D 28/00

(52) U.S. Cl. 701/102

(57) ABSTRACT

A method for the automatic production of map characteristic curve structures for regulating and/or controlling a system. A modeling approach being used for the acquisition of causal dependencies from which, based on measurement data, a map characteristic curve structure is derived. In order to achieve an optimal map characteristic curve structure, the modeling approach has a theoretical data model from which a theoretical model deviation is determined, at least one input quantity of the data model being supplied to a map structure producer for determining a map characteristic curve structure, and the determined map characteristic curve structure being parameterized using measurement data and the result of the parameterization being compared to the theoretical model deviation, and, if a result of the comparison exceeds a specified value, the result of the comparison being resupplied to the map structure producer for the adaptation of the map characteristic curve structure.

### CROSS REFERENCE

The present application claims the benefit under 35 U.S.C. §119 of German Patent Application No. DE 102011002678.9 filed on Jan. 14, 2011, which is expressly incorporated herein by reference in its entirety.

### FIELD OF THE INVENTION

The present invention relates to a method for automatically producing map characteristic curve structures for regulating and/or controlling a system, in particular an internal combustion engine, a modeling approach being used for acquiring causal dependencies within an internal combustion engine, from which approach, based on measurement data, a map characteristic curve structure is derived, and to a device for carrying out the method.

### BACKGROUND INFORMATION

In the development of functions for controlling and/or regulating embedded systems, as is the case for example in the controlling of an internal combustion engine, it is sought to minimize the number of sensors required for the controlling. This goal is achieved through the implementation of so-called gray box models. Such gray box models are required in the internal combustion engine for quantities such as intake manifold pressure, filling, or internal torque. Here, physical model approaches in the form of mathematical equations are used, and at the points at which a physical description is possible only with difficulty, recourse is had to a map characteristic curve structure.

In general, the determination of such a map characteristic curve structure takes place through a manual analysis of the causal dependencies inside the internal combustion engine, the causal dependencies being based on measurement data. Depending on how many influencing parameters must be acquired, this manual analysis can be very time-intensive, certain functional relationships within the causal dependencies being recognizable only after repeated iterations.

In particular in the case of multi-dimensional dependencies, maps of a correspondingly higher dimension or map structures must be used that are made up of a plurality of two-dimensional maps, characteristic curves, and factors. In control devices that regulate or control the internal combustion engine, map structures are used in which the individual maps are limited to two inputs. Such map structures are not optimal, so that the dependency being modeled cannot be mapped exactly in all areas. In addition, a large number of map structures is necessary to describe the dependency being modeled.

### SUMMARY

An object of the present invention is to provide a method for the automatic production of map characteristic curve structures that determines an optimal map structure for an existing causal dependency of the system, in particular of the internal combustion engine.

According to the present invention, this object is achieved in that the modeling approach has a theoretical data model from which a theoretical model deviation is determined, at least one input quantity of the data model being supplied to a map structure producer in order to determine a map characteristic curve structure, and the determined map characteristic curve structure being parameterized using measurement data, and the result of the parameterization being compared to the theoretical model deviation, and, if a result of the comparison exceeds a specified value, the result of the comparison being resupplied to the map structure producer for the adaptation of the map characteristic curve structure. This has the advantage that the map characteristic curve structure produced in this way makes do with a minimum number of maps and map support points for mapping the existing system behavior, in particular of the internal combustion engine. In this method, the map characteristic curve structures representing the causal dependencies are no longer manually determined. In addition, the number of iteration loops for determining the optimal map characteristic curve structure is minimized, because a further modification of the map characteristic curve structure takes place only as long as the result of the comparison exceeds the specified value. If the result of the comparison is below the specified value, it is assumed that the map characteristic curve structure that was produced by the map structure producer adequately maps the causal dependencies that are to be described of the system, in particular the internal combustion engine. The adaptation of the map characteristic curve structure is repeated as long as the result of the comparison between the result of the parameterization and the theoretical model deviation exceeds the specified value.

Advantageously, the input quantities of the theoretical data model are evaluated with regard to their relevance to the data model, and the theoretical model deviation is determined only from relevant input quantities. The use of only relevant input quantities of the data model results in an increase in efficiency in the development of gray box models.

In an embodiment, only relevant input quantities of the data model are supplied to the map structure producer for the determination of the map characteristic curve structure. In this way, a compromise is made between mapping precision and resource requirements in a control device that regulates and/or controls, in particular, the internal combustion engine, because only a small memory space requirement is needed.

In a variant, the type of functional relationship of the relevant input quantities to one another is made known to the map structure producer. This measure can reduce the computing time requirement of the control device, because the number of interpolation operations can be minimized.

In another embodiment, the map structure producer itself determines the relevant input quantities and the type of their functional relationships to one another.

In a development, a number of support points that are to be used are specified to the map structure producer. In this way as well, the memory space requirement within the control device is reduced, and the computing time requirement for determining the map characteristic curve structure is reduced.

In addition, structural elements are specified to the map structure producer. As structural elements, characteristic curves and maps are used that are known as such. The minimization of the number of maps or characteristic curves reduces the application expense in the determination of the optimal map characteristic curve structure. Furthermore, the memory space requirement for the known characteristic curves and maps inside the control device is reduced.

In addition, mathematical operations are specified to the map structure producer. In this way, an automatic map structure production is possible in which the computing expense is limited by the specification of limited mathematical operations.

In an embodiment, only the four basic calculation types are admitted as mathematical operations. This further simplifies the computing process in the creation of the map characteristic curve structure.

In a further variant, conditions concerning the smoothness of the map characteristic curve structure that is to be determined are specified to the map structure producer. In this way, it is ensured that the map characteristic curve structure that is to be determined has, despite slight fluctuation ranges, a high degree of precision compared to the theoretical data model. The developer is provided with a method with which he can comparatively evaluate different structures, incorporating the specified and explained criteria.

A development of the present invention relates to a device for automatically producing map characteristic curve structures for regulating and/or controlling a system, in particular an internal combustion engine, a modeling approach being used for the acquisition of causal dependencies from which approach, based on measurement data, a map characteristic curve structure is derived. In order to determine an optimal map structure for an existing causal dependency within the system, in particular within the internal combustion engine, in the controlling and/or regulation thereof, an arrangement is provided that includes as a modeling approach a theoretical data model, and that determine from the theoretical data model a theoretical model deviation, at least one input quantity of the data model being supplied to a map structure producer in order to determine a map characteristic curve structure, and the determined map characteristic curve structure being parameterized using measurement data, and the result of the parameterization being compared to the theoretical model deviation, and, if the result of the comparison exceeds a specified value, the result of the comparison being resupplied to the map structure producer for the adaptation of the map characteristic curve structure. This has the advantage that the map structures are comparatively robust against errors in the experimental process, the map structures being formed on the basis of knowledge about the system, in particular an internal combustion engine. The map structures contain information about the causal dependencies of the real system, such as the internal combustion engine, and are easy to understand. A combination with physical models is therefore easily possible.

The present invention admits of numerous specific embodiments. One of these is explained in more detail on the basis of the Figures.

### BRIEF DESCRIPTION OF THE DRAWINGS

FIG. 1 shows a schematic representation of a determination of map characteristic curve structures using a physical model.

FIG. 2 shows an exemplary embodiment of the method according to the present invention in the determination of a map characteristic curve structure for describing the effects not mapped in the physical model.

### DETAILED DESCRIPTION OF EXAMPLE EMBODIMENTS

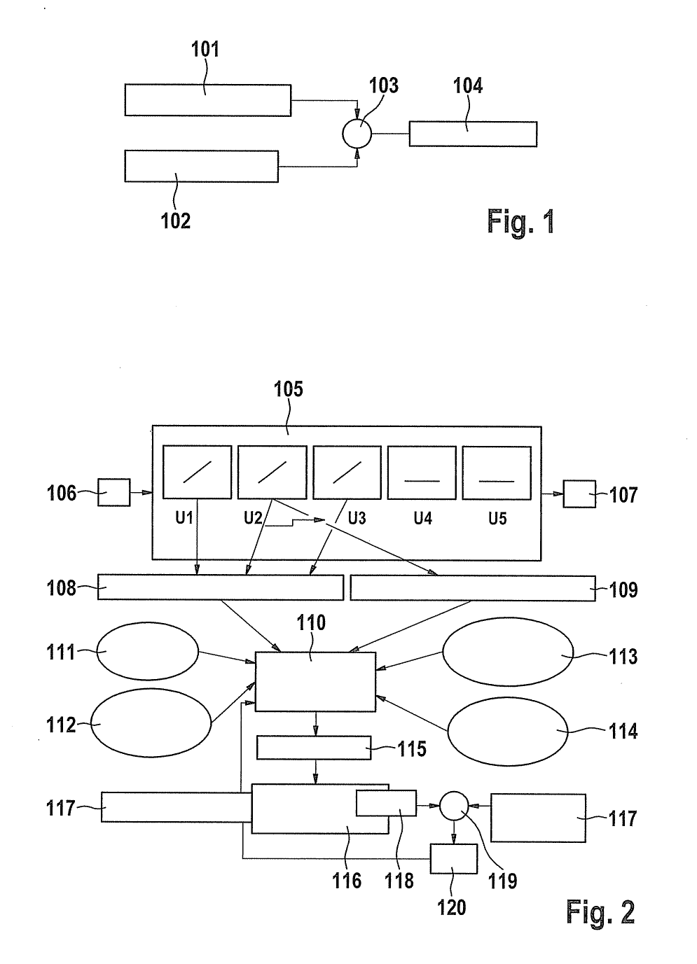

With the aid of the processes shown in FIGS. 1 and 2, the creation of a gray box model is explained. In such a gray box model, physical modeling approaches are used, and at the points at which a physical description is possible only with difficulty a map characteristic curve structure is used.

In FIG. 1, a physical model 101 is used that describes particular causal dependencies of an internal combustion engine using mathematical equations. The computing results achieved using the equations are compared, at node point 103, with actually measured values 102 of the internal combustion engine, and from physical model 101 and measurement values 102 a difference is formed that represents a deviation 104 of the real measured values from the physical model 101.

A possible exemplary embodiment of the method according to the present invention is shown in FIG. 2. Here, in order to produce gray box models, in principle the process executes a number of steps. In the first step, a physical data model 105 is created by setting up, for the real system, physical equations that map the system behavior of the internal combustion engine in a particular operating range. Using these equations, data model 105 is implemented in a simulation program or in a programming language. Input quantities 106 are allocated to physical data model 105 that are processed within data model 105 using the particular equations, and as a result yield a model deviation 107 from the real measurement.

In order to determine model deviation 107, physical data model 105 must be parameterized. This takes place on the basis of direct measurements of individual parameters, e.g., of geometric data or of the mass. The parameterization of theoretical data model 105 takes place through experiments aimed at determining individual input quantities 106 (e.g., oscillation in order to determine the moment of inertia about an axis, or throughput quantities on a test bench in order to determine the flow resistance, or by optimizing input quantities 106 on the basis of measurement data). When data model 105 has been parameterized, the remaining model deviation 107 can be identified using the output of data model 105 and the measurement values. Here it is assumed as a basis that the determination of model deviation 107 of data model 105 has been determined over all input parameters 106, and the model deviation 107 is subsequently stored.

In a further step, the complete input parameters U1, U2, U3, U4, U5 of data model 105 are evaluated in order to determine whether they have a relevant influence on model deviation 107. As can be seen from FIG. 2, input parameters U1, U2, U3 are relevant input quantities 106, and are thus provided, in block 108, as input quantities for a map characteristic curve structure that is still to be determined. Input parameters U4 and U5 have no influence on model deviation 107, and are not further taken into account in the rest of the process.

In the next step, data model 105 determines the type of functional relationship 109 to one another of input parameters U1, U2, U3 determined to be relevant. This functional relationship 109 can for example be described by a factor.

Input quantities 106 determined to be relevant, as well as the type of functional relationship 109 of input quantities 106 determined to be relevant, are then supplied to a map structure producer 110. Map structure producer 110 is based on various rules according to which map structure producer 110 automatically determines the possible map characteristic curve structures. Through the map characteristic curve structure produced by map structure producer 110, the causal dependencies inside the internal combustion engine that cannot be captured by mathematical equations are mapped.

The automatic production of the map structure requires, in addition to the criterion of precision, the inclusion of further rules. Thus, smoothness specifications 111 are given to the map structure producer. In addition, specifications are made of mathematical operations 112, which are limited to the basic calculation types addition, division, multiplication, and subtraction. In addition, a number of support points 113 are specified for the determination of the map characteristic curve structures, support points 113 being limited to a minimum in order to reduce storage capacity. In addition, there takes place a specification of structural elements 114 through the specification of known maps and characteristic curves used by map structure producer 110 in the determination of the optimal map characteristic curve structure for the causal dependency that is to be described.

From relevant input quantities 106 and the specified rules, map structure producer 110 produces a proposal for a map characteristic curve structure 115. This map characteristic curve structure 115 is subjected to a parameterization 116 using measurement quantities 117, yielding a parameterized result 118. This parameterized result 118 is compared to the theoretical model deviation 107 at node point 119 through difference formation. If the difference resulting from parameterization result 118 and model deviation 107 is greater than a specified value 120, specified as a minimum value of the difference, the difference is fed back to map structure producer 110. Map structure producer 110 repeats the process of determining a map characteristic curve structure 115 by again adapting the first-determined characteristic curve map structure 115. The newly determined map characteristic curve structure 115 is again subjected to parameterization 116, and at node point 119 the result of parameterization 118 is again compared to model deviation 107. If this yields a difference that is smaller than specified value 120, it is assumed that map characteristic curve structure 115 optimally describes the specified causal dependency.

However, if the case again occurs in which the difference is greater than specified value 120, map structure producer 110 is again controlled, and a further variation of the map characteristic curve structure is carried out under the influence of the newly found results. This loop can be executed until the difference at node point 119 is smaller than specified value 120 for this difference.

For each automatically produced map characteristic curve structure 115, the data of all maps are optimized with a number of support points. In this way, the suitable structures can be automatically identified. Here, the map characteristic curve structures are evaluated not only with regard to the precision of the mapping of the model counter, but also with regard to their complexity. This complexity evaluation can take place either automatically, according to the number of maps contained, or can be carried out manually by the developer. On the basis of the objective criteria of mapping precision and complexity, the developer can select the best map characteristic curve structures. If required, a further reduction of the support points can subsequently take place, because a large number of support points creates a high memory requirement.

In the use of map characteristic curve structures, it is possible at any time to manually intervene in the parameterization of a control device, no additional mathematical functions and model structures being required in the implementation of the map characteristic curve structures in a control device. Such an experimental process is not mandatory here. Map structures are comparatively robust against errors in the experimental process, and can be formed on the basis of knowledge about the system structure of the internal combustion engine, information about the causal dependencies of the real system of the internal combustion engine being contained in the map characteristic curve structures under certain conditions. Map structures are easy to understand, and can be combined particularly easily with physical models.

In this way, the developer is provided with a method with which he can comparatively evaluate different structures, incorporating the described criteria.

What is claimed is:

1. A method for the automatic production of map characteristic curve structures for regulating and/or controlling an internal combustion engine, the method comprising:
determining a theoretical model deviation from a theoretical data model;
supplying at least one input quantity of the data model to a map structure producer for determining a map characteristic curve structure;
parametizing the determined map characteristic curve structure using measurement data;
comparing a result of the parameterization to the theoretical model deviation; and
supplying a result of the comparison to the map structure producer for adaptation of the map characteristic curve structure if the result of the comparison exceeds a specified value.

2. The method as recited in claim 1, wherein the input quantities of the data model are evaluated with regard to relevance to the data model, the theoretical model deviation being determined only from relevant input quantities.

3. The method as recited in claim 2, wherein only the relevant input quantities of the data model are supplied to the map structure producer for the determination of the map characteristic curve structure.

4. The method as recited in claim 2, wherein a type of functional relationship of the relevant input quantities to one another is made known to the map structure producer.

5. The method as recited in claim 1, wherein the map structure producer determines the relevant input quantities of the data model and a type of functional relationship to one another.

6. The method as recited in claim 1, wherein a number of support points that are to be used is specified to the map structure producer.

7. The method as recited in claim 1, wherein structural elements are specified to the map structure producer.

8. The method as recited in claim 1, wherein mathematical operations are specified to the map structure producer.

9. The method as recited in claim 8, wherein only four basic types of calculation are used as mathematical operations.

10. The method as recited in claim 1, wherein conditions are specified to the map structure producer concerning smoothness of the map characteristic curve structure that is to be determined.

11. A device for the automatic production of map characteristic curve structures for regulating and/or controlling an internal combustion engine, a modeling approach being used for acquisition of causal dependencies within the internal combustion engine, from which approach, based on measurement data, a map characteristic curve structure is derived, the device comprising:
an arrangement that is configured to include the modeling approach as a theoretical data model, and to determine from the theoretical data model a theoretical model deviation, the arrangement configured to supply at least one input quantity of the data model to a map structure producer for determining a map characteristic curve structure, and the determined map characteristic curve structure being parameterized using the measurement data, a result of the parameterization being compared to the theoretical model deviation, and, if the result of the comparison exceeds a specified value, a result of the comparison being resupplied to the map structure producer for adaptation of the map characteristic curve structure.
